(19) United States
(12) Patent Application Publication
(10) Pub. No.: US 2011/0209835 A1
(43) Pub. Date: Sep. 1, 2011

(54) HEADWALL FOR A HOSPTIAL BED

(76) Inventors: Joseph Balbona, Sherman Oaks, CA (US); Kevin Boots, Santa Monica, CA (US); Samantha Rotstein, Los Angeles, CA (US)

(21) Appl. No.: 13/044,511

(22) Filed: Mar. 9, 2011

(51) Int. Cl. A61G 12/00; A47F 10/00

(52) U.S. Cl. 160/127; 52/27

(57) ABSTRACT

A headwall for a hospital bed includes at least exposed one medical care element and at least two panels. Each of the panels differs in at least two of shape, size, color, design, texture or projection. The panels may have a shape suggestive of the at one medical care element. The medical care element may include an electrical or gas outlet, a medical device or a medical accessory, for example examination lights, mounts for equipment, baskets, shelves, and patient monitoring equipment such as blood pressure monitors. The panels minimize the prominence of the outlets/devices and/or accessories. Alternatively, a headwall for a hospital bed includes at least one flexible screen configured to cover at least one medical care element. The screen may be raised, lowered, or slid laterally to uncover and cover the medical care element.

### FIELD OF THE INVENTION

The present invention relates to a headwall for a hospital bed, and more particularly, to a headwall that promotes healing by being aesthetically pleasing while allowing easy access to the outlets/devices and accessories necessary for medical care.

### BACKGROUND

A headwall for use in a hospital room typically refers to the wall behind the head of a hospital bed. The headwall may include a bumper mounted to the wall, against which the hospital bed rests. The headwall above and to the sides of the bed includes several types of medical care elements. These medical care elements include outlets/devices and accessories necessary for medical care, including standard electrical outlets, electrical outlets for low-voltage devices such as a nurse call button, outlets for gasses such as oxygen, medical air and vacuum, mounts for IV bags and other equipment, shelves, baskets, examination lights, patient monitors such as blood pressure monitors, and the like.

However, a patient and the patient's visitors surrounded by all of this medical equipment may become frightened or intimidated. The prominence of the outlets/devices and accessories can contribute to a cold and sterile environment, which can be scary or confusing. These conditions are not conducive to a healing environment. A growing trend in hospital design is to make the rooms more hospitable, warm, and quietly tasteful, like hotel rooms, while maintaining the features needed for efficient and effective medical care.

Some hospital rooms make no attempt to group or gang the medical devices together, and instead install them directly within the wall construction as needed. In many installations, outlets and devices are added over time, contributing to the cluttered and overwhelming look.

Some hospital rooms use manufactured headwall systems that are modular and either surface mounted or recessed panels containing the devices and accessories. Generally selected because of their ability to add or remove devices more easily in the future, these manufactured headwall systems tend to localize and become unintended focal collections of medical technology. Furthermore, as devices and accessories are added to or removed from the headwall over time, there are often inconsistencies in their placement, either in the original installation or in subsequent modifications. These inconsistencies contribute to errors in the delivery of medical care, as staff members waste valuable time orienting themselves to the medical device layout at each hospital bed. This greatly affects patient safety and the quality of medical care.

Some hospital rooms conceal outlets/devices and accessories within cabinets or behind art surrounding the hospital bed. However, the cabinets and art can impede the immediate access to the outlets/devices and accessories needed in an emergency. Because of this concern, many health care providers will leave the cabinets in the open position to save time for medical care and provide constant access to the outlets/devices and accessories. The outlets/devices and accessories are then exposed, and the open cabinets are even more unsightly than outlets/devices and accessories that have been openly mounted to the wall.

Other hospital rooms use paneling to add architectural interest to the headwall. However, the paneling does nothing to hide or minimize the prominence of the outlets/devices and accessories.

When paneling, cabinets, and/or art is used to hide outlets/devices and accessories, it is not possible to change the features when one part or section of the headwall reaches obsolescence or is damaged. The entire headwall system has to be replaced, which is not time efficient, cost efficient or convenient to the hospital.

Some hospital rooms use paneling, cabinets, and/or art to conceal the medical accessories, where the decorative element is age-specific, for example pediatric artwork. The hospital room is then committed to patients of similar ages, which reduces the utilization rate ability of the hospital room.

Structural anchorage is required for headwall systems that are installed in jurisdictions were seismic events occur. Without careful engineering, this can limit the placement of the headwall itself, or affect the ability to maintain and properly clean the headwall.

### SUMMARY OF THE INVENTION

An embodiment of the present invention provides a headwall including at least one medical care element and at least two panels. The medical care element may include an electrical or gas outlet, medical device or a medical accessory, for example examination lights, mounts for equipment, baskets, shelves, and patient monitoring equipment such as blood pressure monitors. The panels differ in at least two of shape, size, color, design, texture or projection. The variation in shape, size, color, design, texture and projection of the panels provides a visual distraction from the medical care element. The panels may have a shape suggestive of the at least one medical care element, which provides camouflage for the medical care element.

The panels may be substantially planar and may be substantially parallel to each other.

The headwall may be modular such that at least one of the panels is configured to be removed and replaced without removing and replacing other components of the headwall. For example, at least one panel is configured to be removed and replaced without removal, replacement, or disruption of the at least one medical care element.

In another embodiment, a headwall includes at least one medical care element and at least two panels. At least one panel is a flexible screen that covers at least one medical care element. The flexible screen may be raised, lowered, or slid laterally, to cover and uncover at least one medical care element. When the screen is raised, it collapses upon itself, for example by rolling, folding or pleating. When the screen is slid laterally, it is partially or fully hidden behind another panel or screen.

The headwall may further include a cornice positioned at the top of the screen, such that when the screen is raised, it collapses upon itself in the region of the cornice.

The screen may be raised, lowered, or slid laterally, manually, or it may be raised, lowered, or slid laterally by a motorized mechanism.

The screen may include a design that coordinates with the area surrounding the screen.

### BRIEF DESCRIPTION OF THE DRAWINGS

FIG. 1 is a perspective view of a headwall according to an embodiment of the present invention with a hospital bed.

FIG. 2 is a front view of the headwall shown in FIG. 1.

FIG. 3 is a sectional side view of the headwall shown in FIG. 1.

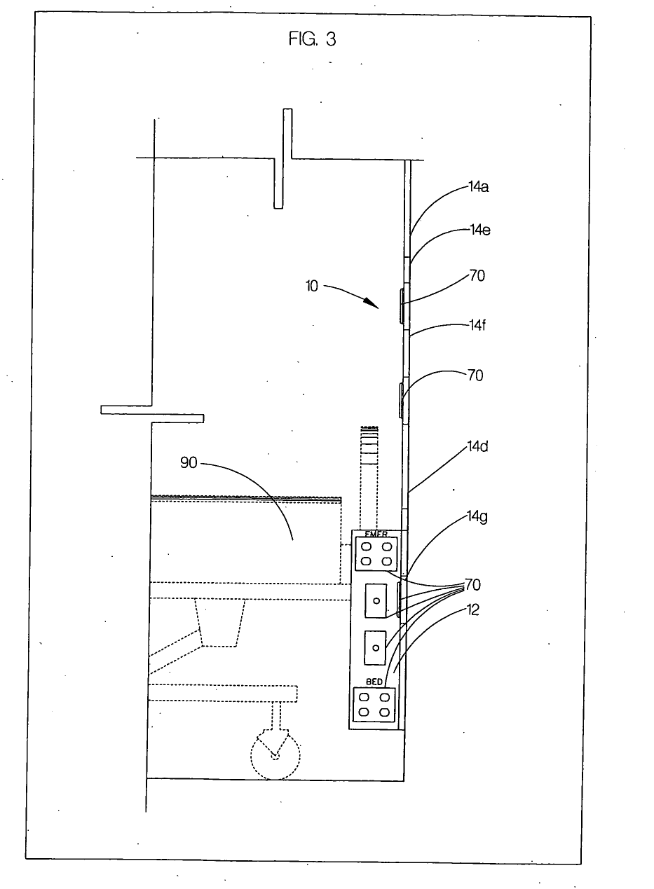

FIG. 4 is a front view of a variation of the headwall shown in FIG. 1.

FIG. 5 is a front view of a second variation of the headwall shown in FIG. 1.

FIG. 6 is a front view of a headwall according to another embodiment of the present invention.

FIG. 7 is a front view of the headwall shown in FIG. 6, with the panels raised.

FIG. 8 is a sectional side view of the headwall shown in FIG. 6.

FIG. 9 is a sectional side view of a headwall according to a variation of the headwall shown in FIG. 6.

FIG. 10 is a front view of a headwall according to another embodiment of the present invention.

FIG. 11 is a front view of the headwall shown in FIG. 10 with the panels slid laterally.

FIG. 12 is a sectional side view of a variation of the headwall shown in FIG. 10.

### DETAILED DESCRIPTION

The detailed description set forth below in connection with the drawings is intended as a description of embodiments of a headwall provided in accordance with the present invention and is not intended to represent the only forms in which the invention may be constructed or utilized. It is to be understood that the same or equivalent functions and structures may be accomplished by different embodiments that are also intended to be encompassed within the spirit and scope of the invention. As denoted elsewhere herein, like element numbers indicate like elements or features.

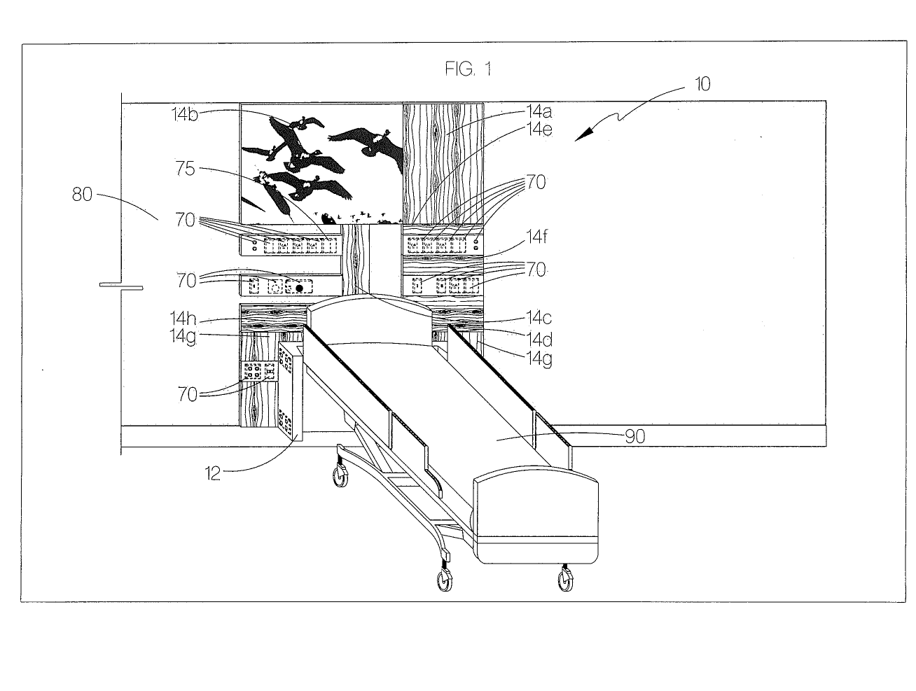

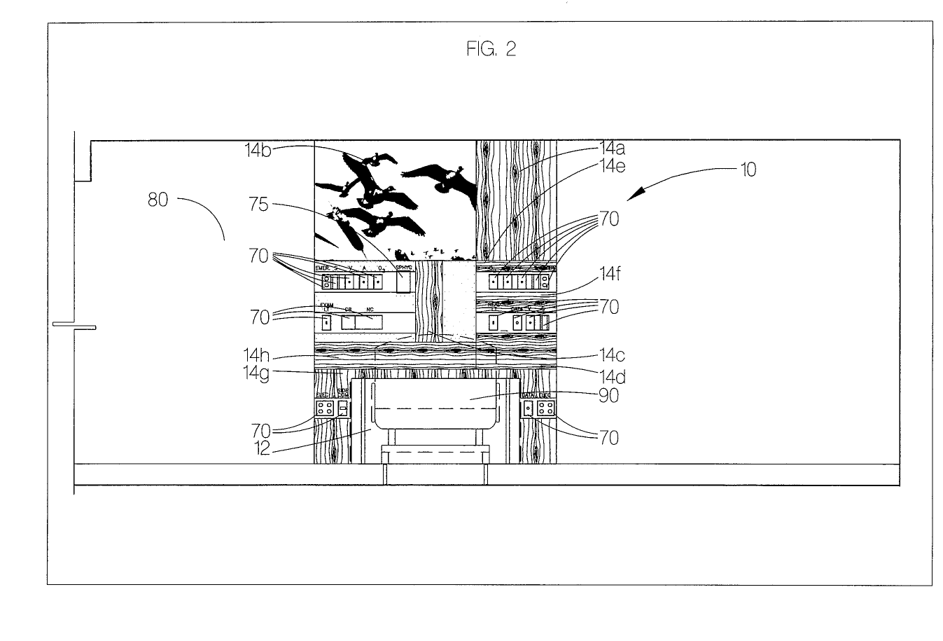

As shown in FIGS. 1 and 2, one embodiment of a headwall 10 includes a bumper element 12 against which a hospital bed 90 may be positioned. In one embodiment, the bumper element 12 is simply a material to provide a target during placement of the bed and to provide some protection for a wall 80. In other embodiments, the bumper element 12 has other features and functionalities, for example standard electrical outlets, an electrical connection for the bed, a connection for a nurse call button, or a mechanism to retain the hospital bed in position.

On the wall 80 above and to the sides of the hospital bed 90, the headwall 10 includes at least one outlet/device 70. Examples of outlets/devices include, but are not limited to, standard electrical outlets, electrical outlets for low-voltage devices such as a nurse call button, and outlets for gasses such as oxygen, medical air and vacuum.

In addition to the outlets/devices 70, the headwall 10 includes at least one medical accessory 75. Examples of a medical accessory include, but are not limited to, mounts for IV bags and other equipment, shelves, baskets, examination lights, patient monitors such as blood pressure monitors, and the like.

The headwall 10 further includes several panels 14a-14i. The panels 14a-14i are substantially planar and substantially parallel to the wall 80. However, the panels 14a-14i may have different sizes, colors, textures, and designs, and furthermore may be positioned different lengths from the wall 80. For example, 14a is a medium-sized vertical rectangle of wood paneling with the wood grain oriented vertically. 14b is a large panel including a decorative print. Similar to 14a, 14c is a vertical rectangle of wood paneling, but is smaller in size. 14d is also a rectangle, but is oriented horizontally. Outlets/devices 70 are mounted above 14d. 14e is a horizontal rectangle, under which outlets/devices 70 are mounted. 14f is another horizontal rectangle with wood grain mounted between two rows of outlets/devices 70. 14g is a rectangle of wood paneling with vertical grain, on top of which outlets/devices 70 and part of bumper 12 are mounted. 14h is a long horizontal rectangle with horizontal grain mounted above 14g. The result is a headwall 10 that camouflages the outlets/devices 70 and accessories 75 by providing decorative and tasteful visual distractions.

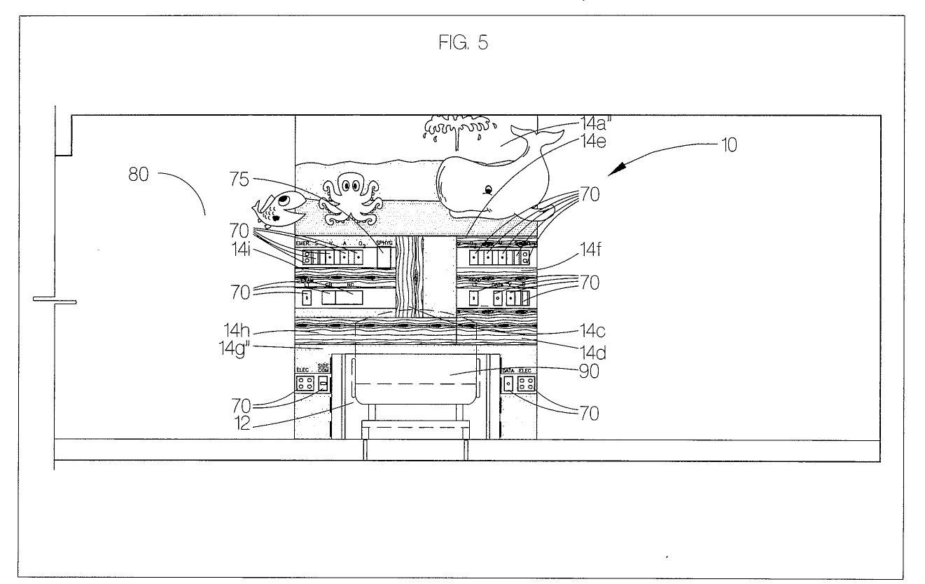

In addition, the substantially planar panels may have three-dimensional aspects such as ridges, corrugation, projections, ripples or textures. The panels may also have irregular edges, for example panel 14a″, shown in FIG. 5.

A variation of this embodiment of the headwall includes some panels that project farther from the wall than others.

In one embodiment, the headwall is modular to allow certain sections or portions to be repaired without requiring replacement of the entire headwall. For example, damaged sections or portions can be removed and replaced without disturbing the entire headwall.

The panels are fastened to the wall with a fastener that allows removal of each panel individually without disruption to the adjacent panels. In one embodiment, the fastener is a concealed-type fastener having a minimally exposed head.

In one embodiment, the fastener meets or exceeds seismic anchorage requirements for the strictest jurisdiction, such that the panels will not require undue engineering substantiation. The fasteners may be pre-approved in jurisdictions where pre-approvals are possible.

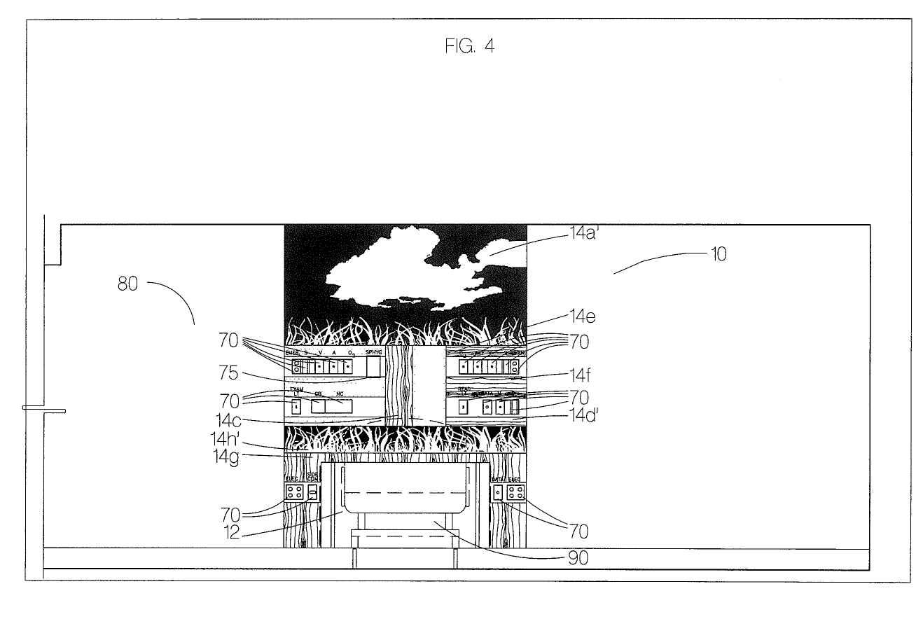

In addition, as shown in FIGS. 2, 4 and 5, the aesthetic of the headwall may be changed by changing only a few of the panels. These small changes can quickly and easily change the aesthetic in order to better serve a particular patient and therefore to improve the patient's hospital experience and increase the utilization rate ability of the hospital room. For example, the headwall in FIG. 2 may be easily changed to the configuration shown in FIG. 4 by changing panels 14a and 14b to 14a′, 14d to 14d′ and 14h to 14h′. Alternatively, the headwall in FIG. 2 may be easily changed to the configuration shown in FIG. 5 by changing panels 14a and 14b to 14a″ and 14g to 14g″.

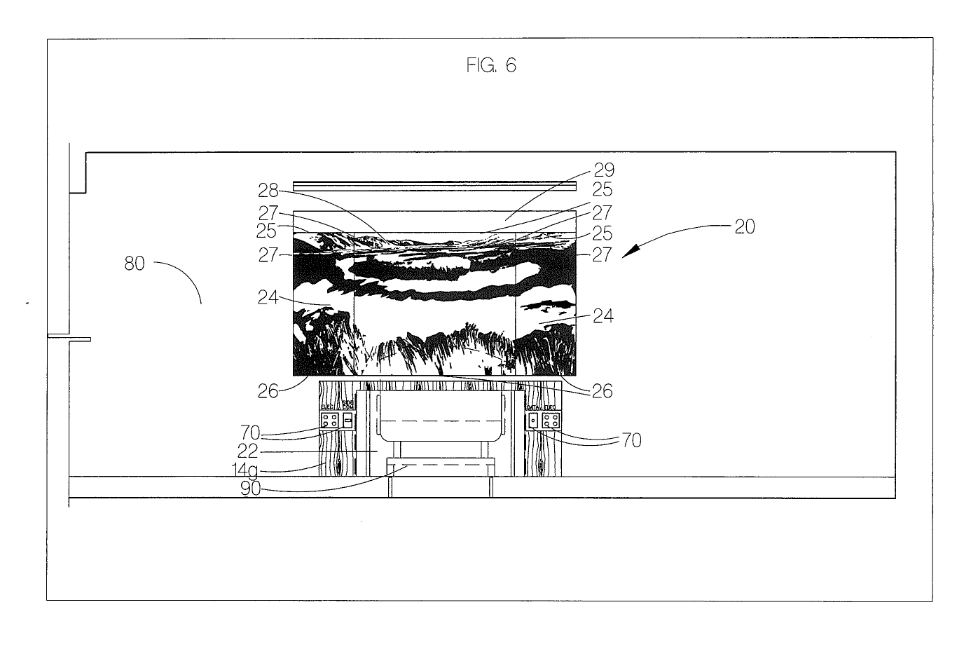

Another embodiment of a headwall 20 is shown in FIGS. 6-8. The headwall 20 includes a bumper 22 that is substantially similar to the bumper 12 of headwall 10. The headwall 20 further includes one or more screens 24 that serve to conceal rather than to distract from the outlets/devices 70 and/or accessories 75 located on the wall 80 behind the screens 24. The screens 24 may include a decorative element such as a design or texture to further provide a visual distraction from any visible outlets/devices 70 and/or accessories 75 and otherwise improve the decor of the hospital room.

The screens 24 are substantially planar and substantially parallel to the wall 80. The screens 24 are flexible and may be similar in construction to window screens. For example, the screens 24 may be roller screens, Roman screens, honeycomb screens, blinds, mini-blinds, matchstick screens, or the like. If necessary, the screens 24 are weighted at the bottom edge 26 to ensure that the screens 24 hang properly.

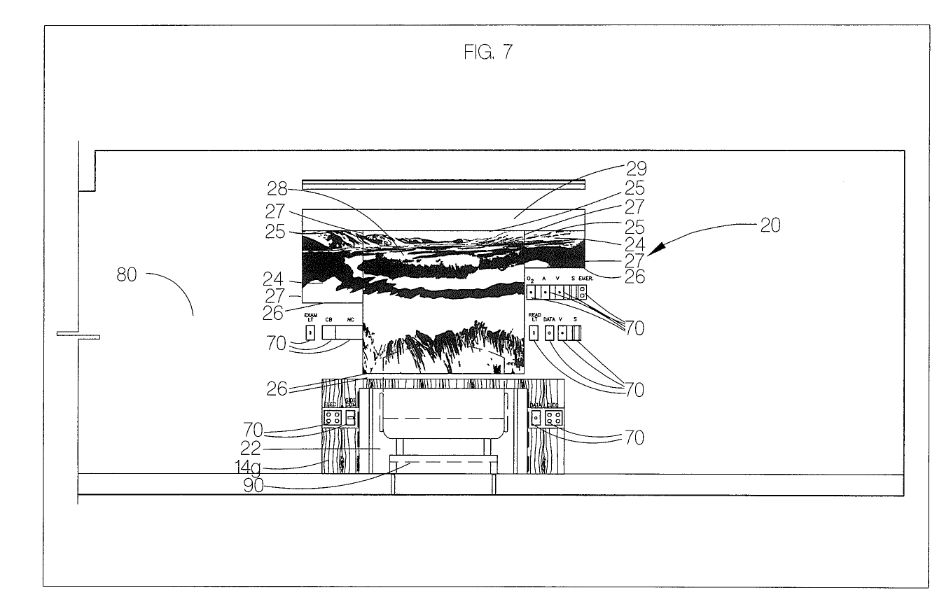

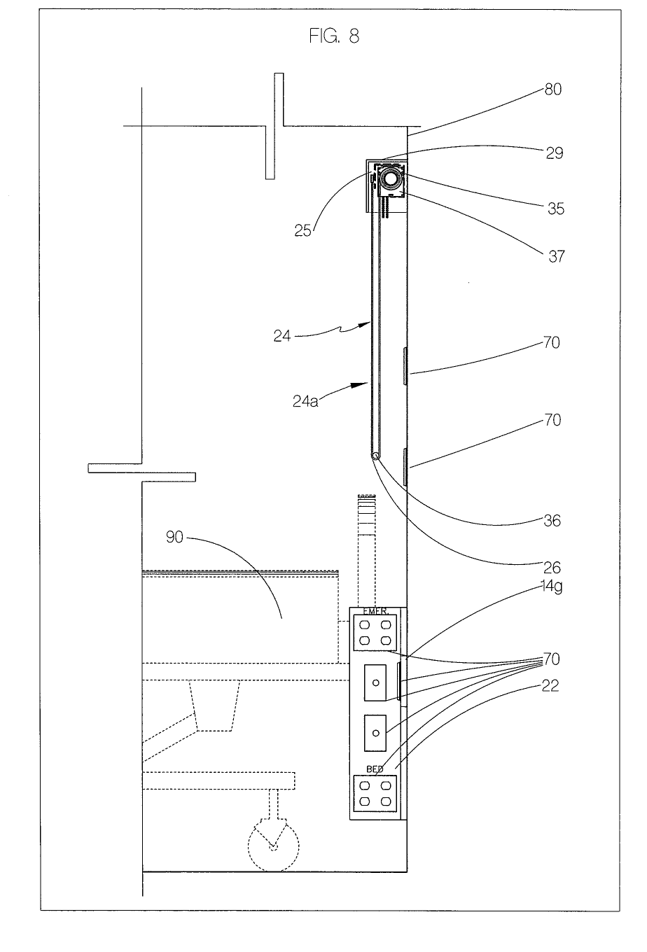

The screen 24 may be raised, as shown in FIGS. 7 and 8, to reveal the outlets/devices 70 and/or accessories 75 located on the wall 80 behind the screen 24. The flexibility of the screen 24 allows the screen 24 to collapse on itself, either at the top 25 or bottom 26 of the screen 24. The collapsing may be accomplished, for example, by rolling, folding or pleating the screen 24.

In one embodiment, shown in FIG. 8, the screen 24 collapses on itself when raised so it does not appear as if something is open or missing. Thus, the outlets/devices 70 and/or accessories 75 are accessible, and at the same time, the aesthetic of the headwall 20 is preserved.

As shown in FIG. 8, one embodiment of the screen 24 includes a cornice 29 mounted over the top 25 of the screen 24. The screen 24 further includes at the bottom 26 a bottom roller 36 and a top roller 35 located near the top 25. The bottom roller 36 acts as a weight to keep the screen 24 hanging straight and substantially parallel to the vertical wall 80. In the lowered position, the screen 24 covers the outlets/devices 70, which are mounted on the wall 80. When the screen 24 is wound around the top roller 35, the bottom roller 36 is pulled up, thus raising the bottom 26 of the screen 24 to expose the outlets/devices 70. In this manner, a design on the front portion 24a of the screen 24 may maintain continuity with surrounding elements. This is advantageous, for example, if the screen 24 is part of a larger mural or other design.

The embodiment shown in FIGS. 6-8 also includes a center panel 28. This center panel 28 may be substantially the same as the screen 24, in that the center panel 28 may be flexible and may be raised and lowered. In this case, the center panel 28 could have outlets/devices 70 and/or accessories 75 located on the wall 80 behind it. Alternatively, the center panel 28 may be stationary. In this case, the center panel 28 need not be flexible, but may comprise any material suitable for a substantially planar decorative element.

In one embodiment, the screens 24 and center panel 28 are positioned on different planes, meaning they are positioned different lengths from, but still substantially parallel to, the wall 80. In another embodiment, the screens 24 and center panel 28 form a single plane.

In one embodiment, the screens 24 are positioned sufficiently far from the wall 80 to allow clearance for all of the outlets/devices 70 and/or accessories 75.

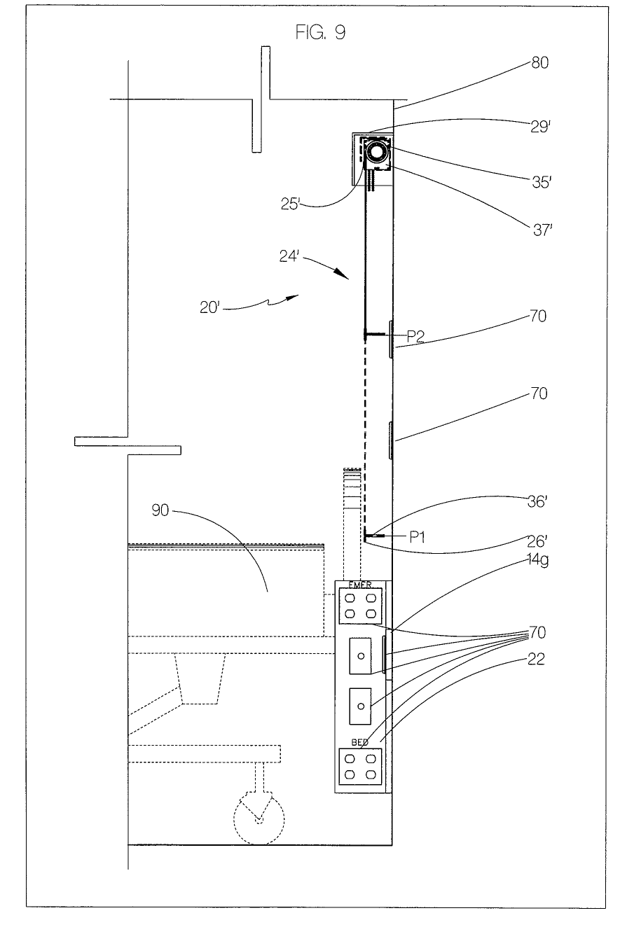

In a variation of an embodiment of a headwall 20′, shown in FIG. 9, the screen 24′ includes a cornice 29′ mounted over the a roller 35′ upon which the screen 24′ is rolled. In the lowered position P1, the screen 24′ covers the outlets/devices 70, which are mounted on the wall 80. When the top 25′ of the screen 24′ is wound around the roller 35′, the bottom 26′ of the screen 24′ is raised to expose the outlets/devices 70 in a second position P2.

As shown in FIGS. 6-9, the headwall 20, 20′ may further include a cornice 29, 29′ above the screen 24, 24′ and/or the center panel 28. In addition to contributing to the visual distraction from any visible outlets/devices 70 and/or accessories 75, the cornice 29, 29′ serves to hide any visible hardware at the top 25, 25′ of the screen 24, 24′.

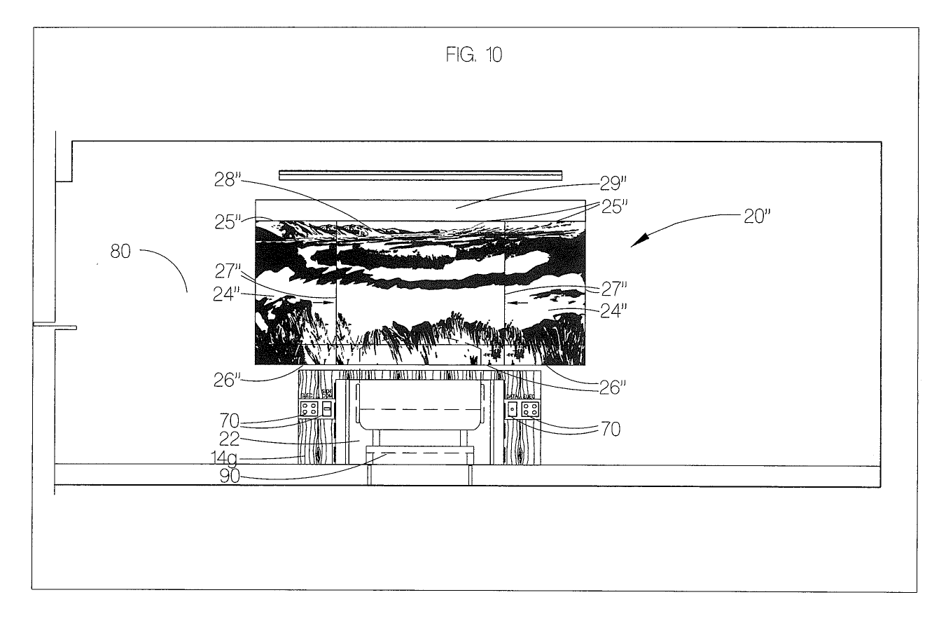

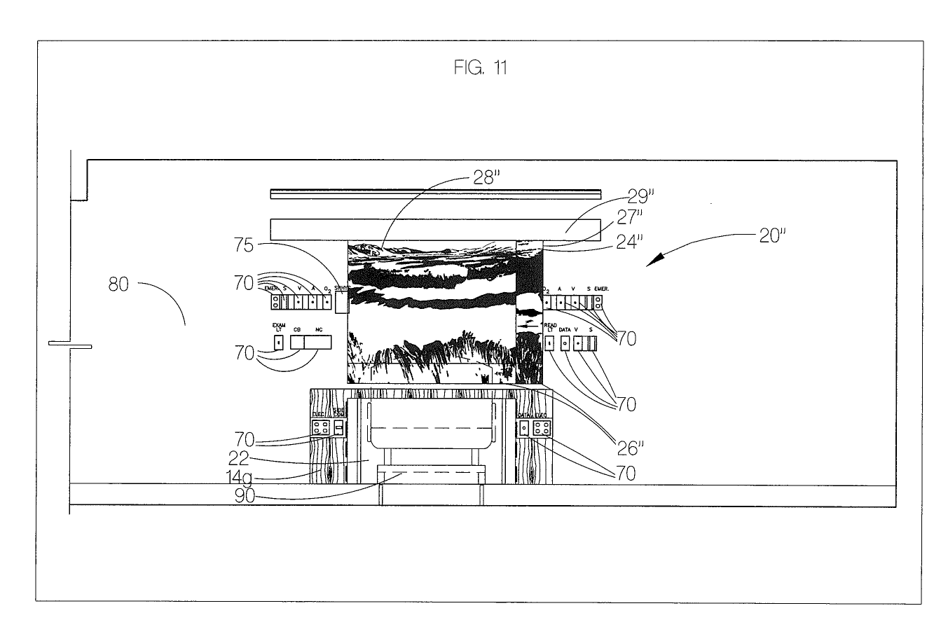

Another embodiment of the headwall 20″ is shown in FIGS. 10 and 11. The headwall 20″ includes one or more screens 24″ that serve to cover the outlets/devices 70 and/or accessories 75 located on the wall 80 behind the screens 24″. Similar to screens 24, 24′, the screens 24″ may include a decorative element such as a design or texture to further provide a visual distraction from any visible outlets/devices 70 and/or accessories 75 and otherwise improve the decor of the hospital room.

The screen 24″ is mounted on a slider track, and may be slid laterally to uncover and cover the outlets/devices 70 and/or accessories 75. In an embodiment, the screen 24″ slides behind the center panel 28″, as shown in FIG. 11. The screen 24″ may be rigid or flexible.

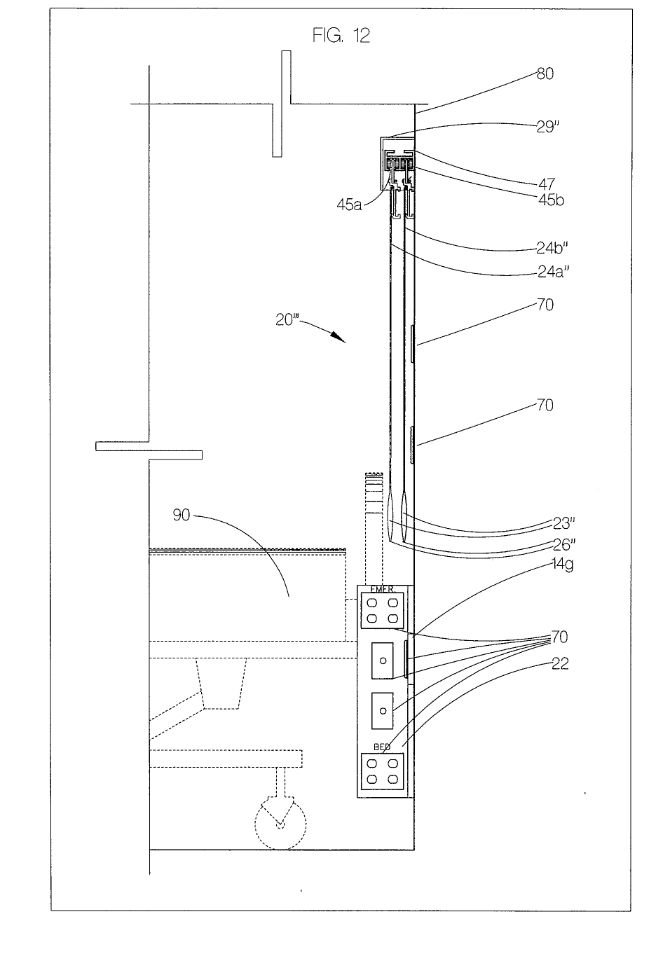

A variation of an embodiment of the headwall 20″' is shown in FIG. 12. This embodiment includes screen 24a″ mounted on slider track 45a, and screen 24b″ mounted on slider track 45b. Slider track 45b is a track parallel to and behind 45a. Both screens 24a″ and 24b″ are capable of sliding laterally on the respective tracks 45a and 45b.

In this embodiment, the screen 24a″ may be a movable center panel 28 that slides to uncover and cover outlets/devices 70 and/or accessories 75 located on the wall 80 behind center panel 28.

Alternatively, the screens 24a″ and 24b″ may both slide behind a stationary center panel 28. In this case, screens 24a″ and 24b″ may incorporate different designs or artwork. For example, screen 24a″ may include a decorative element that is suitable for young children, while screen 24b″ may include a decorative element more suited toward older children or adults. In this way, the headwall 20′″ may be quickly changed to accommodate a range of aesthetic tastes, thus increasing the utilization rate ability of the hospital room.

The mechanism to raise, lower or slide the screen 24, 24′, 24″ may be manual. The screen 24, 24′, 24″ may be raised, lowered or slid directly by hand, or the raising/lowering or sliding mechanism may include mechanical elements such as springs, pulleys, chains, cords, or the like. Alternatively, the screen 24, 24′, 24″ may be raised, lowered or slid by a motorized mechanism 37, 37′, 47. For immediate access to the outlets/devices 70 and accessories 75 behind the screen 24, 24′, 24″ in a medical emergency, the raising/lowering or sliding mechanism preferably includes at least one simple and quick manual method.

A headwall 10 that leaves the outlets/devices 70 and accessories 75 exposed is especially suited for high-risk patients, for example Medical Surgical patients, whose medical care generally requires frequent access to the outlets/devices 70 and accessories 75. A headwall 20, 20′, 20″ including screens 24, 24′, 24″ that completely cover the outlets/devices 70 and accessories 75 is suited for low-risk patients, for example Labor/Delivery/Recovery Postpartum patients, whose medical care may not require constant or frequent access to the outlets/devices 70 and accessories 75 during their entire stay.

In one embodiment, the screens 24, 24′, 24″, center panel 28 and panels 14 are modular. This allows sections to be replaced for repair or decorative reasons without needing to replace the entire headwall. While the artwork, color and size of panels and screens may vary from room to room to provide a pleasing and healing environment, the placement of medical outlets and devices remains consistent from room to room within a unit. This promotes patient safety, as staff will have a uniform expectation of medical device and outlet location. Alternatively, the placement of medical outlets and devices may vary based on patient and/or nursing unit acuity while retaining the organization and/or orientation of the medical outlets and devices.

The headwall may be made of any suitable material, for example materials chosen to limit dust collection and transmission of disease, including nosocomial diseases.

An embodiment of the headwall includes materials and design that allow for accepted industry standard methods of manual cleaning and disinfection.

Although the present invention has been described through the use of exemplary embodiments, it will be appreciated by those of skill in the art that various modifications may be made to the described embodiments that fall within the scope and spirit of the invention as defined by the claims and their equivalents appended hereto. For example, aspects shown above with particular embodiments may be combined with or incorporated into other embodiments. Therefore, the headwall may be adapted to be utilized with any medical setting to provide the features desired.

What is claimed is:

1. A headwall for a hospital bed, comprising:
at least one exposed medical care element; and
at least two panels, each differing in at least two of shape, size, color, design, texture or projection.

2. The headwall according to claim 1, wherein each of the at least two panels has a shape suggestive of the at least one medical care element.

3. The headwall according to claim 1, wherein the at least one medical care element comprises an outlet, the outlet chosen from the group consisting of electrical outlets and gas outlets.

4. The headwall according to claim 1, wherein the at least one medical care element comprises a medical accessory.

5. The headwall according to claim 1, wherein the at least two panels are substantially planar and are substantially parallel to each other.

6. The headwall according to claim 1, wherein the headwall is modular and at least one of the at least two panels is configured to be removed and replaced without removing and replacing other components of the headwall.

7. The headwall according to claim 1, wherein at least one of the at least two panels is configured to be removed and replaced without removing and replacing the at least one medical care element.

8. A headwall for a hospital bed, comprising:
at least one medical care element; and
at least one flexible screen configured to cover the at least one medical care element.

9. The headwall according to claim 8, wherein the at least one medical care element comprises an outlet, the outlet chosen from the group consisting of electrical outlets and gas outlets.

10. The headwall according to claim 8, wherein the at least one medical care element comprises a medical accessory.

11. The headwall according to claim 8, wherein the at least one panel is substantially planar and is substantially parallel to the plane of the headwall.

12. The headwall according to claim 8, wherein the flexible screen may be raised and lowered to uncover and cover at least one medical care element.

13. The headwall according to claim 12, wherein the flexible screen, when raised, collapses upon itself.

14. The headwall according to claim 8 further comprising a cornice positioned above the at least one flexible screen.

15. The headwall according to claim 12 further comprising a cornice positioned above the at least one flexible screen, wherein the flexible screen, when raised, collapses upon itself in the region of the cornice.

16. The headwall according to claim 12, wherein the flexible screen, when raised, collapses upon itself at a region at the bottom of the screen.

17. The headwall according to claim 12, wherein the flexible screen is raised and lowered manually.

18. The headwall according to claim 12, wherein the flexible screen is raised and lowered by a motorized mechanism.

19. The headwall according to claim 8, wherein the screen comprises a design that coordinates with the area surrounding the screen.

20. The headwall according to claim 8, wherein the headwall is modular and the at least one panel is configured to be removed and replaced without removing and replacing other components of the headwall.

21. The headwall according to claim 8, wherein the at least one screen is configured to slide laterally to uncover and cover at least one medical care element.

22. A headwall for a hospital bed, comprising:
at least one medical care element;
a first component; and
at least one sliding panel that is configured to slide laterally to cover and uncover the at least one medical care element,
wherein the at least one sliding panel is configured to uncover the at least one medical care element by sliding behind the first component.
